(19) United States
(12) Patent Application Publication
(10) Pub. No.: US 2008/0150762 A1
(43) Pub. Date: Jun. 26, 2008

(54) Device For Detecting Vehicles and Traffic Control System Equipped With a Device of This Type

(75) Inventor: Jo Versavel, Kortrijk (BE)

Correspondence Address: JAMES C. WRAY, 1493 CHAIN BRIDGE ROAD, SUITE 300, MCLEAN, VA, 22101, US

(73) Assignee: Traficon NV

(21) Appl. No.: 11/883,855

(22) PCT Filed: Feb. 7, 2006
(86) PCT No.: PCT/IB06/00228

§ 371 Date: Aug. 7, 2007

(30) Foreign Application Priority Data
Feb. 7, 2005 (BE) BE-2005/0068

(51) Int. Cl. G08G 1/042

(52) U.S. Cl. 340/941

(57) ABSTRACT

This invention relates, on the one hand, to a device for detecting vehicles, comprising a loop detection unit (1) which is designed to interwork with an inductive loop detector, whereby an inductive electrical circuit (5) is connected to the loop detection unit (1), whereby the inductance of this circuit (5) can be modified by means of an electronic control means (6), and whereby the detection device comprises a detector (4) which is designed to influence the aforementioned electronic control means. On the other hand, this invention relates to a traffic control system equipped with a device of this type.

This invention relates, on the one hand, to a device for detecting vehicles, comprising a loop detection unit which is designed to interwork with an inductive loop detector. On the other hand, this invention relates to a traffic control system equipped with a device of this type.

The device according to the invention is used, on the one hand, to detect vehicles, for example in toll stations, or, on the other hand, to control lights or measure traffic.

Known traffic control systems for detecting vehicles, as described in the British patent publications GB 1 157 082 and GB 1 146 953, and the American patent publication U.S. Pat. No. 3,818,430, have a standard detection unit (central unit), in which a number of standard detection cards are located, with the electronics of the traffic control system. These cards have connection points for one or more detection loops which are disposed under the road surface.

If a vehicle is located above one of these loops, the inductance of the respective loop will change and the vehicle will be detected.

Experience has shown that the aforementioned traffic control systems, which operate on the basis of loop detection, regularly short-circuit. As a result, there is an increasing tendency to switch over to other detection technologies, for example: video detection, radar detection, infrared detection, ultrasound detection, laser detection, etc. These technologies can forward information to the central unit either with closed contacts or via a serial connection.

However, in order to enable existing traffic control systems to operate with other detection technologies, the standard loop detection cards must be replaced with an adapted interface which operates on the basis of this other detection technology. This replacement is usually quite expensive and must be carried out by highly trained personnel. Furthermore, the necessary adaptations are not always possible because, in some traffic control systems, the central unit may not be opened, otherwise the warranty will lapse.

The object of the invention is to provide a device for detecting vehicles which allows the detection technology to be changed simply and quickly, without the standard loop detection cards having to be replaced, and a traffic control system equipped with a device of this type.

The object of the invention is achieved, on the one hand, by providing a device for detecting vehicles, comprising a loop detection unit which is designed to interwork with an inductive loop detector, whereby an inductive electrical circuit is connected to the loop detection unit, whereby the inductance of this circuit can be modified by means of an electronic control means, and whereby the detection device comprises a detector which is designed to influence the aforementioned electronic control means in the detection of a vehicle, so that a modified inductance is produced which is an emulation of a loop detector.

Emulation of a loop detection means that a signal is created just as if a loop detector were present.

The electronic control means, preferably a switch or electronic circuit, is preferably controlled by a digital output signal from the detector. An electronic control means in this patent application means any electronic circuit or device which can modify an inductance.

In a preferred device according to the invention, the aforementioned inductive electrical circuit is designed to be connected to the connection points of the inductive loop detector. With the adaptation of an existing installation, the terminals which are now provided for the inductive loop can thereby be used to signal the presence of vehicles.

The term “detector” is used in this patent application in the broadest sense of the word, i.e. any given means for carrying out a detection. Detectors can be divided up into different types, according to their operating principle. In a particular preferred embodiment of the device according to the invention, the detector which is used is a video detector, an infrared detector, an ultrasound detector, an acoustic detector or a laser detector, the different operating principles of which are generally known.

According to this invention, the inductance of a loop detector and the change therein due to the presence of a vehicle is emulated via the aforementioned inductive electrical circuit. The conditions for standard detection cards to detect the presence of a vehicle are created in this manner. The main advantage thereof is that other detectors, for example a video detector, can now be connected to existing control centres without the standard detection cards having to be replaced with an adapted interface.

In known devices for detecting vehicles, the detection unit is designed to interwork with a plurality of loop detectors, which are disposed under the road surface. The advantage of the device according to the invention is that all of these loop detectors can be replaced by one detector, for example a camera.

In a further particular device according to the invention, the inductive electrical circuit comprises at least one coil with an inductance which matches the inductance of the loop detector. The inductance of the coil can be modified via the switch. If the detector detects a vehicle, the inductance of the coil will change, thereby creating the conditions for standard detection cards to detect the presence of a vehicle.

On the other hand, the object of the invention is achieved by providing a traffic control system which is equipped with a device according to the invention, as described above.

A more detailed description of the device according to the invention is provided below in order to explain the characteristics of this invention in more detail, and to indicate additional advantages and special features thereof. It will be evident that nothing in the description below can be interpreted as a restriction of the protection for this invention which is claimed in the claims.

In this description, reference figures are used to refer to the attached drawings, in which:

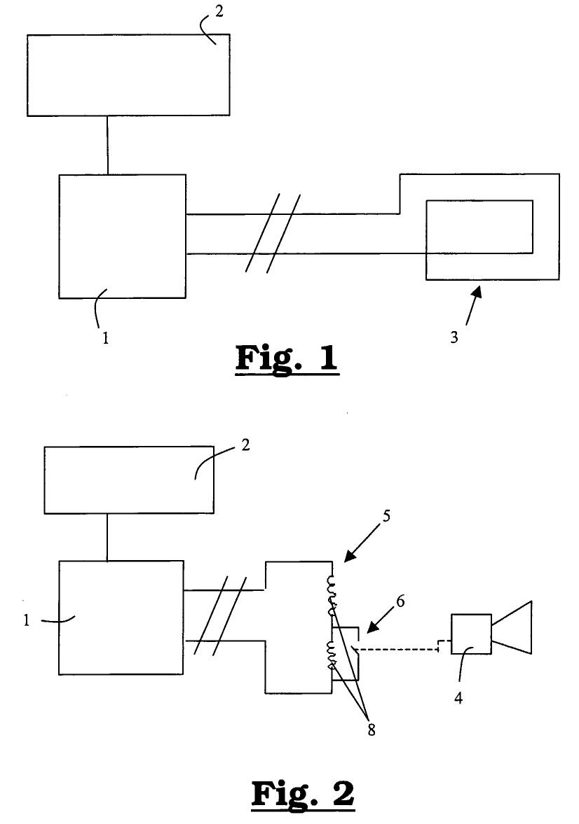

FIG. 1 is a schematic representation of an existing device for detecting vehicles, comprising a loop detection unit which is designed to interwork with an inductive loop detector installed in the road surface;

FIG. 2 is a schematic representation of the device according to the invention;

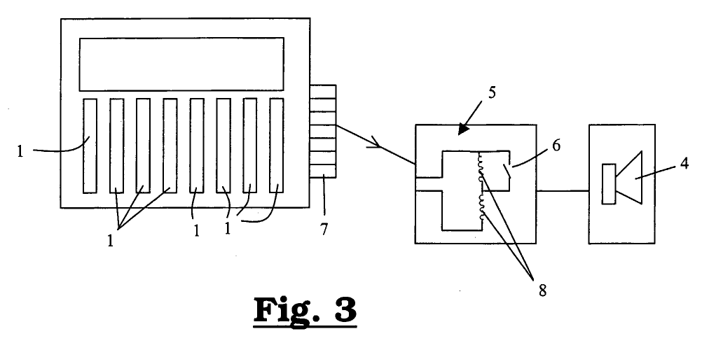

FIG. 3 is a schematic representation of the device according to the invention, indicating the different detection cards and connection points.

The device according to this invention is intended to detect vehicles, pedestrians, etc. Existing traffic control systems, as shown in FIG. 1, are provided with a loop detection unit (1) (also referred to as a central unit), in which a number of standard detection cards are located, with the electronics of the traffic control system. These cards have connection points (7) for one or more inductive loop detectors (3) which are disposed under the road surface. In known loop systems of this type, a vehicle is detected in that this vehicle changes the inductance of the detection loop, given that the vehicle is a metal object moving in relation to the inductive loop.

However, in order to enable known systems to operate with other detection technologies, such as video, radar, infrared, acoustic, ultrasound and laser detection, the standard detection cards must be replaced with an adapted interface which operates on the basis of this other detection technology.

In order to continue using existing detection cards for detection technologies other than the loop system, an inductive electrical circuit (5) is now connected to existing connection points (7) of the loop detection unit (1), as shown in FIGS. 2 and 3. The inductance of this circuit (5) can be modified by means of an electronic control means, particularly a switch (6), although other electronic controls are also possible. The device according to this invention further comprises a detector (4), for example video, radar, infrared, acoustic, ultrasound and laser detectors, which are designed to influence the aforementioned switch (6) in the detection of a vehicle.

The inductive electrical circuit (5) comprises at least one coil (8) with an inductance value which matches the inductance of the loop detector. The inductance of the coil can be modified via the switch. If the detector, for example a camera (4), detects a vehicle, the inductance of the coil will change. The conditions for the detection card to detect the presence of a vehicle are created in this manner.

The digital output signal from the detector (not a loop detector) is used to switch the electronic circuit (5), thereby causing the inductance to change, as would occur with a loop detector.

With a device of this type according to the invention, an existing central unit (1) with loop detection can be used for other types of detector, without the loop detection cards from that central unit (1) having to be replaced. An existing central unit, provided, for example, with eight loop detectors, can thus be replaced with eight inductive circuits (5) which are connected to one camera (4), to be connected to existing connection points (7) of the loop detectors.

1. Device for detecting vehicles, comprising a loop detection unit (1) which is designed to interwork with an inductive loop detector (3), wherein an inductive electrical circuit (5) is connected to the loop detection unit (1), the inductance of this circuit (5) can be modified by means of an electronic control means (6), and the detection device comprises a detector (4) which is designed to influence the aforementioned electronic control means in the detection of a vehicle, so that a modified inductance is produced which is an emulation of a loop detection.

2. Device for detecting vehicles according to claim 1, wherein the aforementioned inductive electrical circuit (5) is designed to be connected to the connection points of the inductive loop detector (3).

3. Device for detecting vehicles according to claim 1, wherein the aforementioned detector is a video detector, an infrared detector, an ultrasound detector, an acoustic detector or a laser detector.

4. Device for detecting vehicles according to claim 1, wherein the inductive electrical circuit (5) comprises at least one coil with an inductance which matches the inductance of the loop detector.

5. Traffic control system, wherein it comprises a device according to claim 1.
